(19) United States
(12) Patent Application Publication
(10) Pub. No.: US 2017/0255370 A1
(43) Pub. Date: Sep. 7, 2017

(54) INFORMATION PROCESSING APPARATUS, AND CONTROL METHOD AND CONTROL PROGRAM THEREOF

(71) Applicant: NEC Corporation, Tokyo (JP)

(72) Inventor: Satoru ISHII, Tokyo (JP)

(73) Assignee: NEC Corporation, Tokyo (JP)

(21) Appl. No.: 15/510,811

(22) PCT Filed: Jul. 28, 2015
(86) PCT No.: PCT/JP2015/071421

§ 371 Date: Mar. 13, 2017

(30) Foreign Application Priority Data
Sep. 16, 2014 (JP) 2014-188309

(51) Int. Cl. G06F 3/0484

(52) U.S. Cl. CPC G06F 3/04845; G06F 3/04883

(57) ABSTRACT

There is provided an information processing apparatus for providing, at the time of a predetermined operation, screen display which is easier to see. The information processing apparatus includes a display unit that arranges a first display frame and a second display frame side by side on a screen, displays, in the first display frame, information generated by a first application, and displays, in the second display frame, information generated by a second application, an operation unit that accepts an operation by a user, and a display controller that changes, if an operation for the first application is accepted, a size of the first display frame.

### TECHNICAL FIELD

The present invention relates to an information processing apparatus, and a control method and control program thereof.

### BACKGROUND ART

In the above technical field, patent literature 1 discloses a technique of changing the display range of a display screen divided into two parts (see paragraph [0358]).

### CITATION LIST

### Patent Literature

Patent literature 1: International Publication No. 2008/090902

### SUMMARY OF THE INVENTION

### Technical Problem

However, the technique described in the above literature only changes the display range by waiting for a user operation, and cannot provide, at the time of a predetermined operation, screen display which is easier to see, thereby impairing the usability.

The present invention enables to provide a technique of solving the above-described problem.

### Solution to Problem

One aspect of the present invention provides an apparatus comprising:
a display unit that arranges a first display frame and a second display frame side by side on a screen, displays, in the first display frame, information generated by a first application, and displays, in the second display frame, information generated by a second application;
an operation unit that accepts an operation by a user; and
a display controller that changes, if an operation for the first application is accepted, a size of the first display frame.

Another aspect of the present invention provides a control method of an information processing apparatus including a display unit that arranges a first display frame and a second display frame side by side on a screen, displays, in the first display frame, information generated by a first application, and displays, in the second display frame, information generated by a second application, and an operation unit that accepts an operation by a user, the method comprising:
changing, if an operation for the first application is accepted, a size of the first display frame.

Still other aspect of the present invention provides a control program of an information processing apparatus including a display unit that arranges a first display frame and a second display frame side by side on a screen, displays, in the first display frame, information generated by a first application, and displays, in the second display frame, information generated by a second application, and an operation unit that accepts an operation by a user, for causing a computer to execute a method, comprising:
changing, if an operation for the first application is accepted, a size of the first display frame.

### Advantageous Effects of Invention

According to the present invention, it is possible to provide, at the time of a predetermined operation, screen display which is easier to see.

### BRIEF DESCRIPTION OF DRAWINGS

FIG. 1 is a block diagram showing the arrangement of an information processing apparatus according to the first embodiment of the present invention;

FIG. 2A is a view showing a display example by an information processing apparatus according to the second embodiment of the present invention;

FIG. 2B is a view showing another display example by the information processing apparatus according to the second embodiment of the present invention;

FIG. 2C is a view showing still other display example by the information processing apparatus according to the second embodiment of the present invention;

FIG. 3A is a block diagram for explaining the functional arrangement of the information processing apparatus according to the second embodiment of the present invention;

FIG. 3B is a block diagram for explaining the functional arrangement of the information processing apparatus according to the second embodiment of the present invention;

FIG. 4 is a table for explaining the structure of a table used by the information processing apparatus according to the second embodiment of the present invention;

FIG. 5 is a view for explaining the structure of a table used by the information processing apparatus according to the second embodiment of the present invention;

FIG. 6 is a block diagram for explaining the hardware arrangement of the information processing apparatus according to the second embodiment of the present invention; and

FIG. 7 is a flowchart for explaining the processing procedure of the information processing apparatus according to the second embodiment of the present invention.

### DESCRIPTION OF THE EMBODIMENTS

Preferred embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

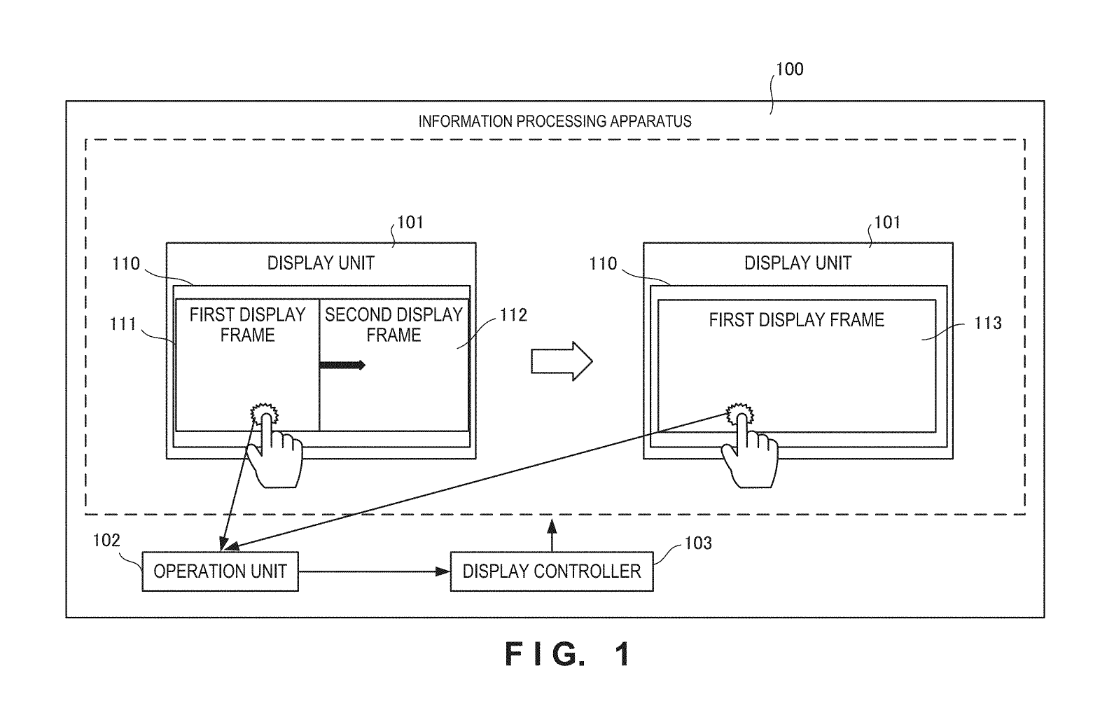

An information processing apparatus 100 according to the first embodiment of the present invention will be described with reference to FIG. 1. As shown in FIG. 1, the information processing apparatus 100 includes a display unit 101, an operation unit 102, and a display controller 103.

The display unit 101 arranges a first display frame 111 and a second display frame 112 side by side on a screen 110, and displays, in the first display frame 111, information generated by the first application. The display unit 101 also displays, in the second display frame 112, information generated by the second application.

The operation unit 102 accepts an operation by the user.

If an operation for the first application is accepted, the display controller 103 changes the size of the first display frame 111.

This can improve the visibility during the operation of the application.

### Second Embodiment

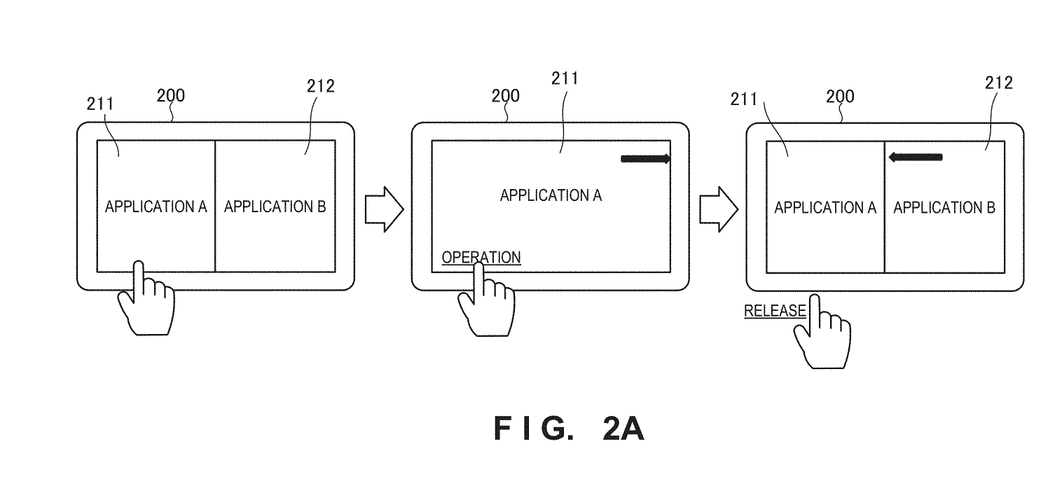

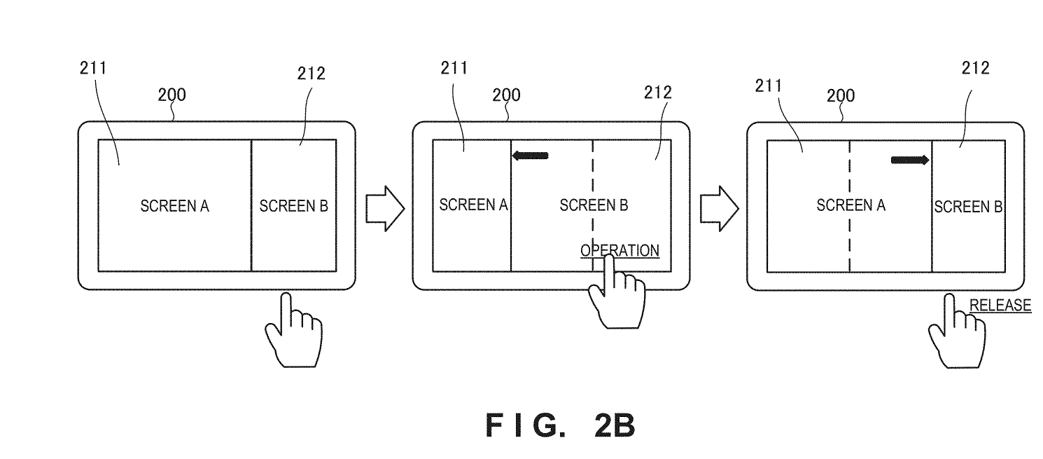

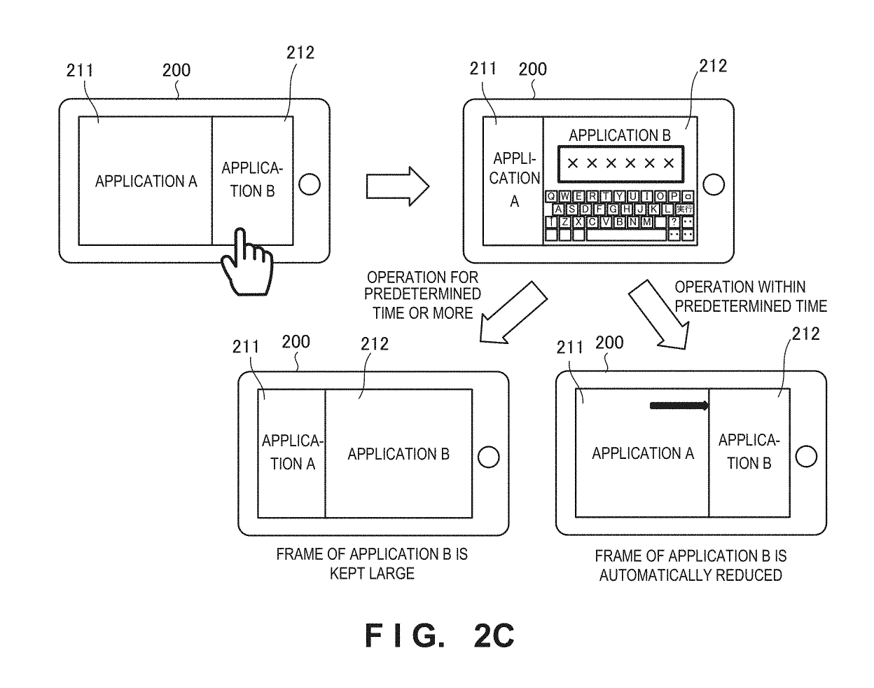

An information processing apparatus according to the second embodiment of the present invention will be described next with reference to FIG. 2A and subsequent drawings. FIGS. 2A and 2B are views for explaining screen transition of an information processing apparatus 200 according to this embodiment. The information processing apparatus 200 is an apparatus with which a display screen is integrally formed, such as a smartphone or smart device.

As shown in FIG. 2A, the information processing apparatus 200 can display display frames 211 and 212 side by side on a screen 210. Images generated by different applications A and B can be simultaneously displayed in the display frames 211 and 212. As an example, icons generated by application A are displayed in the display frame 211. Furthermore, a table generated by a spreadsheet application is displayed in the display frame 212.

In this state, if an operation (for example, a tap or long touch) is performed for application A, the information processing apparatus 200 increases the width of the display frame 211 to perform full-screen display, and sets the display frame 212 in a non-display state. Upon end of the operation (for example, the tap or long touch) for application A, the information processing apparatus 200 returns the widths of the display frames 211 and 212 to those before the operation.

On the other hand, as shown in FIG. 2B, in accordance with an operation (for example, a tap or long touch) for application B, the information processing apparatus 200 may increase the width of the display frame 212, and decrease the width of the display frame 211. In this case as well, upon end of the operation (for example, the tap or long touch) for application B, the information processing apparatus 200 returns the widths of the display frames 211 and 212 to those before the operation.

Furthermore, as shown in FIG. 2C, the display frame of application B may be enlarged and displayed while a keyboard image is displayed, and the display frame 211 of application A may be reduced and displayed. In addition, if an operation such as an editing operation for application B is continuously performed for a predetermined time or more, the enlarged display frame 212 of application B is maintained. On the other hand, if the operation such as the editing operation for application B ends within the predetermined time, the size of the display frame 212 of application B is returned to the original one.

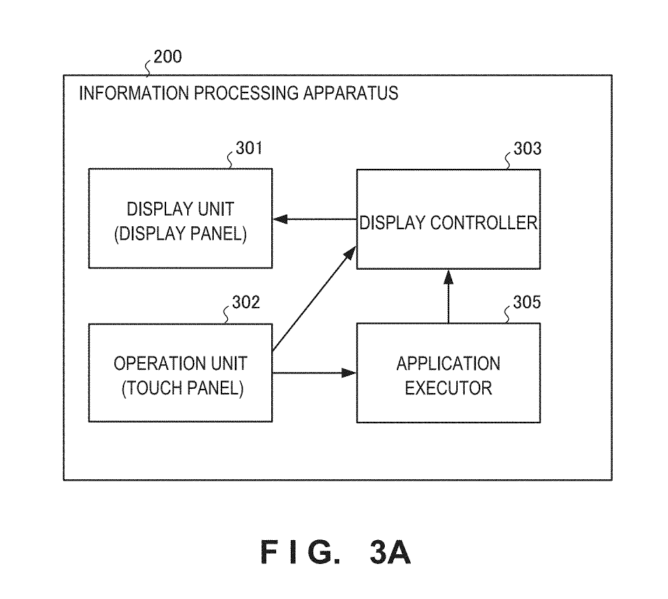

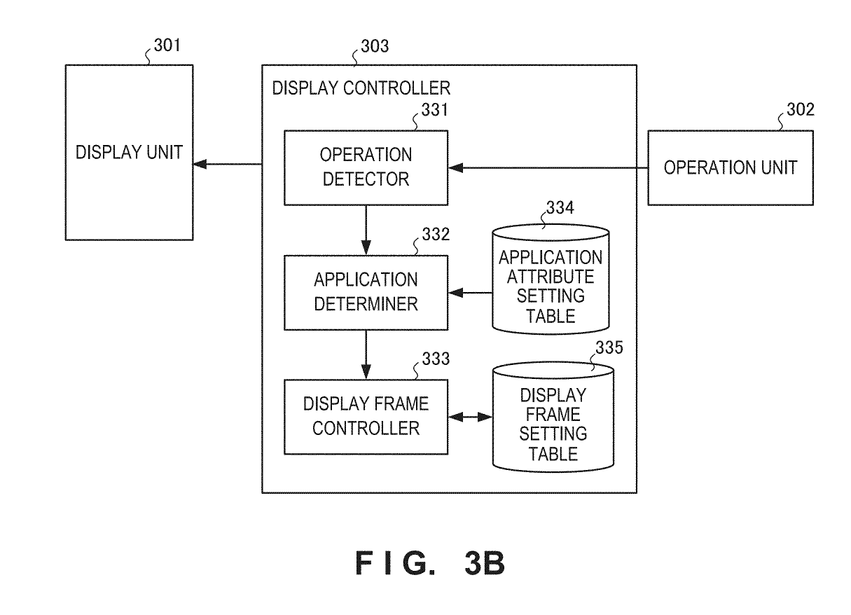

FIG. 3A is a block diagram showing the functional arrangement of the information processing apparatus 200. The information processing apparatus 200 includes a display panel as a display unit 301, a touch panel as an operation unit 302, a display controller 303, and an application executor 305.

The application executor 305 executes an application in response to a user operation on the operation unit 302. An application execution result is sent to the display controller 303.

The display controller 303 generates a display image in accordance with the application execution result. At this time, in accordance with settings (the upper limit of the display frame count and the like) input from the operation unit 302, the display controller 303 generates at least one display frame, and displays it so that it is possible to discriminate an active display frame from an inactive display frame.

For example, if the upper limit of the display frame count is set to one, the display controller 303 always performs full-screen display. If the upper limit of the display frame count is set to two, when one application is executed, full-screen display is performed. However, in a state in which two or more applications are executed, the execution results of two applications are arranged and displayed in two display frames. This allows the user to see the execution results of the plurality of applications at the same time. The display frame count may be settable to three or more, as a matter of course. Furthermore, the arrangement of the respective display frames may be freely settable. Alternatively, when the display frame count is determined, the positions of the respective display frames may be automatically determined.

A functional arrangement in which the number of display frames to be simultaneously displayed can be selected every time may be adopted. For example, in a state in which four applications are executed, one of the applications may be selected and undergo full-screen display or two of the applications may be selected and undergo 2-division display (the display frame count is two).

Under the control of the display controller 303, the display unit 301 arranges the display frames 211 and 212 side by side on the screen 210, and displays, in the display frames 211 and 212, pieces of information generated by the different applications.

FIG. 3B is a block diagram showing the internal arrangement of the display controller 303. The display controller 303 includes an operation detector 331, an application determiner 332, a display frame controller 333, a application attribute setting table 334, and a display frame setting table 335.

Based on, for example, a notification from the operation unit 302, the operation detector 331 determines whether an application has accepted an operation. If an operation event has occurred, the application determiner 332 is notified of it. The application determiner 332 determines the relationship between the state of the application which has accepted the operation and an application (another application) simultaneously displayed with the application. A determination result is sent to the display frame controller 333. In principle, the display frame controller 333 enlarges the display frame of the application which has accepted the operation, and reduces the display frame of the other application or sets the display frame in the non-display state. Before the enlargement/reduction processing, the sizes of the respective display frames are stored in the display frame setting table 335.

Conversely, if the priority level of the other application is higher than that of the application which has accepted the operation, display may be performed without enlarging the display frame of the application which has accepted the operation and changing the size of the display frame of the other application.

Furthermore, the display frame controller 333 has a measurement function of measuring an elapsed time after the operation detector 331 stops detecting the operation, and returns the sizes of the display frames along with a lapse of the predetermined time. In this example, the operation includes various operations such as scroll and editing operations in addition to a touch by a finger.

The display frame controller 333 measures the time during which the operation detector 331 continuously detects the operation. If the operation time exceeds the predetermined time, the display frame controller 333 maintains the sizes of the display frames.

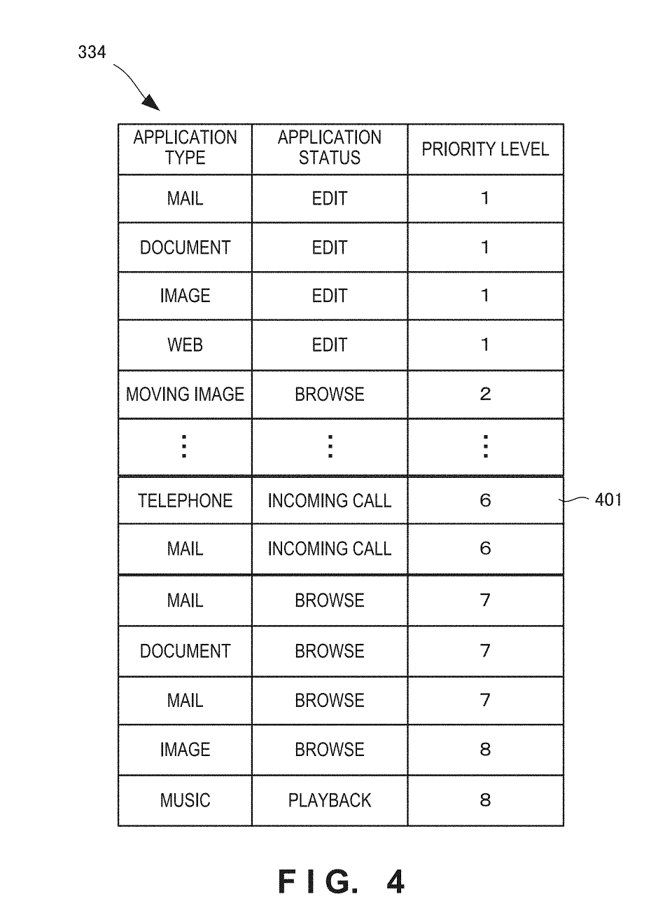

The application attribute setting table 334 sets a priority level to indicate an application to be preferentially displayed. The application attribute setting table 334 has, for example, a structure shown in FIG. 4, in which priority levels are assigned to various statuses for each application type.

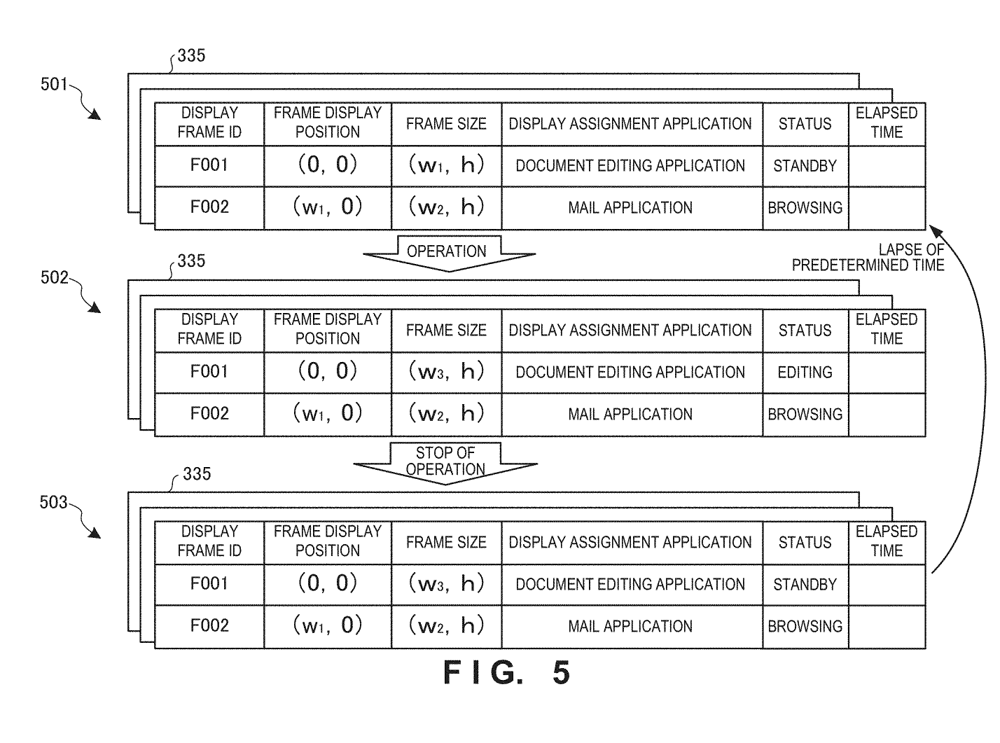

The display frame setting table 335 has, for example, a structure shown in FIG. 5. The display frame setting table 335 shown in FIG. 5 is prepared for each display frame count, in which a display frame ID, a frame display position, a frame size, a display assignment application, a status, and an elapsed time are set. That is, in a state 501 on the upper side of FIG. 5, a display frame with an ID “F001” is displayed at a position of coordinates (0, 0) in a size (width, height)=(w1, h). On the other hand, a display frame with an ID “F002” is displayed at a position of coordinates (w1, 0) in a size (width, height) (W2, h). As an example, a document editing application is assigned to the display frame F001, and a mail application is assigned to the display frame F002.

In this state, if an operation event occurs, the display frame setting table 335 changes to a state 502 in which the frame size of the frame F001 is enlarged to a size (w3, h), and the frame position and size of the frame F002 are reduced to a position (w3, 0) and a size (w4, h). These changes implement the change of the display shown in FIG. 2B.

On the other hand, upon end of the operation for the document editing application, the display frame setting table 335 changes to a state 503. In this state, an elapsed time is measured. If the predetermined time elapses after the end of the operation for the document editing application, the display frame setting table 335 returns to the state 501. These changes implement the change of the display shown in FIG. 2C.

If the display frame count is three, three display frame IDs “F001” to “F003” are set, and the table has three rows.

### <<Hardware Arrangement of Information Processing Apparatus>>

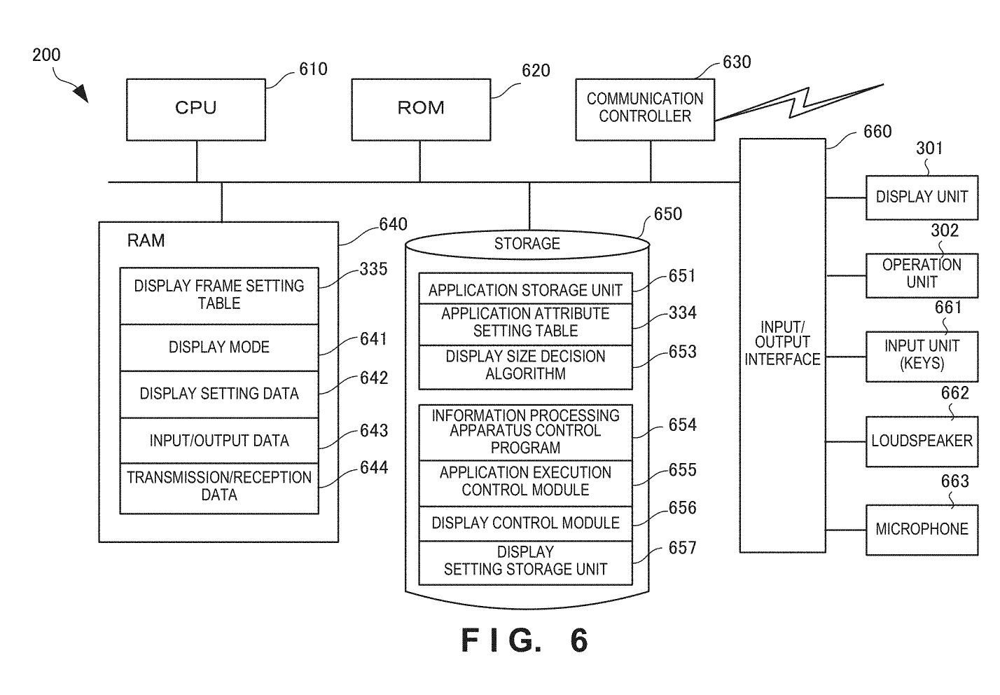

FIG. 6 is a block diagram showing the hardware arrangement of the information processing apparatus 200 according to this embodiment.

Referring to FIG. 6, a CPU (Central Processing Unit) 610 is an arithmetic control processor, and implements the functional components of the information processing apparatus 200 shown in FIG. 3A by executing a program. A ROM (Read Only Memory) 620 stores permanent data such as initial data and a program, and programs. A communication controller 630 communicates with another apparatus via a network. Note that the number of CPUs 610 is not limited to one, and a plurality of CPUs or a GPU (Graphical Processing Unit) for image processing may be included. The communication controller 630 desirably includes a CPU independent of the CPU 610, and writes or reads out transmission/reception data in or from the area of a RAM (Random Access Memory) 640. It is desirable to provide a DMAC (Direct Memory Access Controller) (not shown) for transferring data between the RAM 640 and a storage 650. Furthermore, an input/output interface 660 desirably includes a CPU independent of the CPU 610, and writes or reads out input/output data in or from the area of the RAM 640. Therefore, the CPU 610 processes the data by recognizing that the data has been received by or transferred to the RAM 640. Furthermore, the CPU 610 prepares the processing results of various applications in the RAM 640, and delegates succeeding transmission or transfer to the communication controller 630, DMAC, or input/output interface 660.

The RAM 640 is a random access memory used as a temporary storage work area by the CPU 610. An area to store data necessary for implementation of the embodiment is allocated to the RAM 640. As an example, the RAM 640 stores the display frame setting table 335, a display mode 641 such as a full-screen display mode, 2-division display mode, or 3-division display mode, and display setting data 642 such as the sizes of the respective display frames. The RAM 640 temporarily stores input/output data 643 and transmission/reception data 644. The input/output data 643 are transfer data exchanged with the display unit 301 and the operation unit 302 via the input/output interface 660. The transmission/reception data 644 are data transmitted/received via the communication controller 630.

The storage 650 stores a database, various parameters, or the following data or programs necessary for implementation of the embodiment. An application storage unit 651 stores applications executable by the information processing apparatus 200. A display size decision algorithm 653 stores a processing scheme of enlarging and reducing display data.

The storage 650 further stores the following programs. An information processing apparatus control program 654 is a basic program for controlling the overall information processing apparatus 200. An application execution control module 655 is a module for executing applications stored in the application storage unit 651. A display control module 656 is a module for performing display control according to the display frame setting table 335. More specifically, the display control module 656 controls the arrangement, on the display unit 301, of the display frames assigned with pieces of display information generated by executing the applications.

The input/output interface 660 interfaces input/output data with an input/output device. The input/output interface 660 is connected to the display unit 301, the operation unit 302, an input unit 661 with hardware keys, a loudspeaker 662, a microphone 663, and the like. Although not shown, the input/output interface 660 is connected to a GPS (Global Positioning System) position determiner, an acceleration sensor, a geomagnetic sensor, and the like.

### <<Processing Procedure of Information Processing Apparatus>>

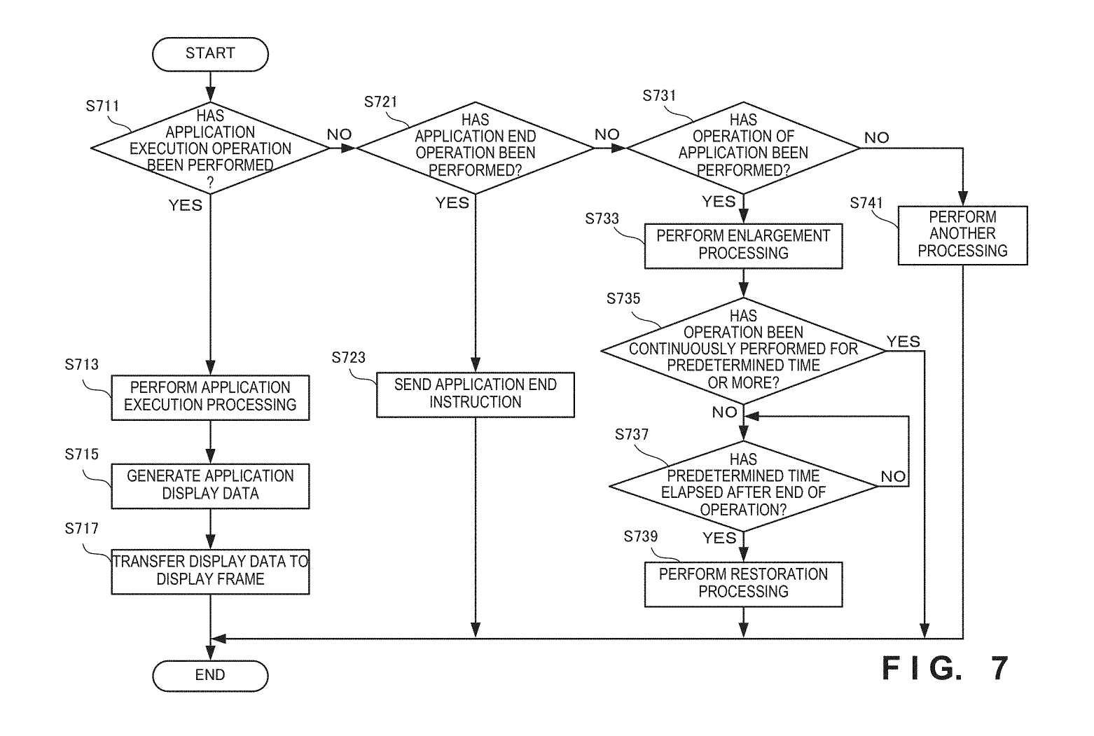

FIG. 7 is a flowchart illustrating the processing procedure of the information processing apparatus 200 according to this embodiment. The respective processes of this flowchart are executed by the CPU 610 of FIG. 6 using the RAM 640, thereby implementing the functional components shown in FIG. 3A.

In step S711, the information processing apparatus 200 determines whether an application execution operation has been performed on a display screen. If an application execution operation has been performed, the information processing apparatus 200 executes an instructed application in step S713. In step S713, the information processing apparatus 200 generates display data related to execution of the application. In step S715, the information processing apparatus 200 transfers the generated display data to display it in an assigned display frame.

If no application execution operation has been performed, the information processing apparatus 200 determines in step S721 whether an operation of ending the currently executed application has been performed. If the operation of ending the currently executed application has been performed, the information processing apparatus 200 ends the instructed application in step S723.

If neither an application execution operation nor an application end operation has been performed, the information processing apparatus 200 determines in step S731 whether an operation event has occurred in one of the applications. Examples of the operation event are a document editing operation in the document editing application, a reply mail creation operation in the mail application, a call origination operation in an Internet phone application, and a moving image browsing operation in an Internet browser. The present invention, however, is not limited to them.

If an operation event for the application occurs, the information processing apparatus 200 advances from step S731 to step S733, and enlarges the display frame of the application for which the operation has been performed.

In step S735, the information processing apparatus 200 determines whether the operation of the application has been continuously performed for a predetermined time or more.

If the operation ends without continuously performing the operation for the predetermined time or more, and a predetermined time elapses after the end of the operation, the process advances from step S737 to step S739, and processing of restoring the display state to that before the operation is performed.

As described above, according to this embodiment, since the operated application is automatically enlarged, it is possible to improve the visibility during the operation of the application. Since the size of the application which has been continuously operated for the predetermined time is fixed, it is possible to display, in a large size, the application important for the user.

### Other Embodiments

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

The present invention is applicable to a system including a plurality of devices or a single apparatus. The present invention is also applicable even when an information processing program for implementing the functions of the embodiments is supplied to the system or apparatus directly or from a remote site. Hence, the present invention also incorporates the program installed in a computer to implement the functions of the present invention by the computer, a medium storing the program, and a WWW (World Wide Web) server that causes a user to download the program. Especially, the present invention incorporates at least a non-transitory computer readable medium storing a program that causes a computer to execute processing steps included in the above-described embodiments.

This application claims the benefit of Japanese Patent Application No. 2014-188309 filed on Sep. 16, 2014, which is hereby incorporated by reference herein in its entirety.

1. An information processing apparatus comprising:
a display unit that arranges a first display frame and a second display frame side by side on a screen, displays, in the first display frame, information generated by a first application, and displays, in the second display frame, information generated by a second application;
an operation unit that accepts an operation by a user; and
a display controller that changes, if an operation for the first application is accepted, a size of the first display frame.

2. The information processing apparatus according to claim 1, wherein if the operation for the first application is accepted, said display controller changes the first display frame to be larger.

3. The information processing apparatus according to claim 1, wherein if the operation for the first application is accepted, said display controller changes the first display frame to be larger than that before the operation.

4. The information processing apparatus according to claim 1, wherein if the operation for the first application ends, said display controller changes the first display frame to be smaller than that during the operation.

5. The information processing apparatus according to claim 1, wherein if a predetermined time elapses after the operation for the first application ends, said display controller changes the first display frame to be smaller than that during the operation.

6. The information processing apparatus according to claim 1, wherein if the operation for the first application is accepted, said display controller performs full-screen display of the first display frame.

7. The information processing apparatus according to claim 1, wherein if the operation for the first application is accepted, said display controller displays the first display frame in a size larger than that before the operation, and displays the second display frame in a size smaller than that before the operation.

8. A control method of an information processing apparatus including a display unit that arranges a first display frame and a second display frame side by side on a screen, displays, in the first display frame, information generated by a first application, and displays, in the second display frame, information generated by a second application, and an operation unit that accepts an operation by a user, the method comprising:
changing, if an operation for the first application is accepted, a size of the first display frame.

9. A non-transitory computer readable medium storing a control program of an information processing apparatus including a display unit that arranges a first display frame and a second display frame side by side on a screen, displays, in the first display frame, information generated by a first application, and displays, in the second display frame, information generated by a second application, and an operation unit that accepts an operation by a user, for causing a computer to execute a method, comprising:
changing, if an operation for the first application is accepted, a size of the first display frame.
